(19) United States
(12) Patent Application Publication
(10) Pub. No.: US 2012/0088495 A1
(43) Pub. Date: Apr. 12, 2012

(54) Apparatuses, Systems, and Methods for Connection Setup

(75) Inventor: Wei-Chieh Tsai, Taipei Hsien (TW)

(73) Assignee: ACER INCORPORATED, Taipei Hsien (TW)

(21) Appl. No.: 13/073,892

(22) Filed: Mar. 28, 2011

(30) Foreign Application Priority Data
Oct. 12, 2010 (TW) 99134684

(51) Int. Cl. H04W 76/02

(52) U.S. Cl. 455/422.1

(57) ABSTRACT

A mobile communications apparatus with a wireless module and a controller module is provided. The wireless module is arranged for performing wireless transceiving operations to and from a service network. The controller module is arranged for transmitting a first connection request message to the service network via the wireless module, and determining whether a connection rejection message indicating network congestion has been received from the service network via the wireless module, or whether a predetermined period of time corresponding to the first connection request message has expired. Also, the controller module is arranged for transmitting a second connection request message to the service network and waiting to receive, on a Forward Access CHannel (FACH), a subsequent response message from the service network via the wireless module, in response to the connection rejection message being received or the predetermined period of time being expired.

### CROSS REFERENCE TO RELATED APPLICATIONS

This application claims priority of Taiwan Patent Application No. 99134684, filed on Oct. 12, 2010, the entirety of which is incorporated by reference herein.

### BACKGROUND OF THE INVENTION

1. Field of the Invention

The invention generally relates to mobile communication technologies, and more particularly, to a connection setup technique for utilizing network resources efficiently.

2. Description of the Related Art

The Universal Mobile Telecommunications System (UMTS), as one of the third generation of mobile communications technologies, was developed from the Global System for Mobile communications (GSM) and incorporates the core network of the GSM with Wideband Code Division Multiple Access (WCDMA) technology to provide a higher transceiving rate and better service quality. Generally, in a UMTS, a mobile communications apparatus (or referred to as a User Equipment (UE)) needs to perform a connection setup procedure to obtain wireless services from a service network.

In the Release 7 of the UMTS specifications standardized by the 3rd Generation Partnership Project (3GPP), a Downlink Shared CHannel (DSCH) has been newly proposed as one of the logical channels, in addition to the Dedicated CHannel (DCH). A UE may determine whether a base station supports the DSCH according to the broadcasted system information. If the DSCH is supported, the UE may configure the DSCH as the default downlink channel for performing a connection setup procedure. To further clarify, the UE may transmit, on a Random Access CHannel (RACH), an RRC (Radio Resource Control) CONNECTION REQUEST message to the service network where the base station belongs. If the connection request is accepted, the UE may receive an RRC CONNECTION SETUP message from the service network and establish a connection with the service network according to the configuration indicated in RRC CONNECTION SETUP message, as shown in FIG. 1. Note that the UE needs to monitor the DSCH after the transmission of the RRC CONNECTION REQUEST message since the RRC CONNECTION SETUP message is transmitted on the DSCH. After the connection setup is completed, the UE may transmit, on a dedicated channel or the RACH (depending on the operation status of the UE), an RRC CONNECTION SETUP COMPLETE message to the service network to end the connection setup procedure.

In another situation where network congestion occurs, e.g., when too many UEs flock into a service area or network resources get overloaded by user requests, the UE may receive an RRC CONNECTION REJECT message from the service network after the transmission of the RRC CONNECTION REQUEST message, as shown in FIG. 2. However, the RRC CONNECTION REJECT message only indicates that the rejection cause is network congestion, and no information is provided concerning which channel the congestion has occurred on. As a result, the UE may only try to retransmit the RRC CONNECTION REQUEST message to the service network until an RRC CONNECTION SETUP message has been received or a maximum number of retries is reached.

### BRIEF SUMMARY OF THE INVENTION

Accordingly, embodiments of the invention provide apparatuses, systems, and methods for connection setup. In one aspect of the invention, a mobile communications apparatus including a wireless module and a controller module is provided. The wireless module is arranged for performing wireless transceiving operations to and from a service network. The controller module is arranged for transmitting a first connection request message to the service network via the wireless module, and determining whether a connection rejection message indicating network congestion has been received from the service network via the wireless module, or whether a guard period of time corresponding to the first connection request message has expired. Also, the controller module is arranged for transmitting a second connection request message to the service network and waiting to receive, on a Forward Access CHannel (FACH), a subsequent response message from the service network via the wireless module, in response to the connection rejection message being received or the guard period of time being expired. Specifically, the first connection request message and the second connection request message are generated according to a first version and a second version of a communication protocol, respectively.

In another aspect of the invention, a connection setup method for a mobile communications apparatus with a wireless module is provided. The connection setup method may include the steps of transmitting a first connection request message to the service network via the wireless module, determining whether a connection rejection message indicating network congestion has been received from the service network via the wireless module, or whether a guard period of time corresponding to the first connection request message has expired, and transmitting a second connection request message to the service network and waiting to receive, on a Forward Access CHannel (FACH), a subsequent response message from the service network via the wireless module, in response to the connection rejection message being received or the guard period of time being expired. Specifically, the first connection request message and the second connection request message are generated according to a first version and a second version of a communication protocol, respectively.

In another aspect of the invention, a mobile communications system including a service network and a mobile communications apparatus is provided. The service network is arranged for receiving a first connection request message, transmitting a connection rejection message when network congestion occurs, and transmitting a subsequent response message on a FACH in response to receiving a second connection request message, wherein the first connection request message and the second connection request message are generated according to a first version and a second version of a communication protocol, respectively. The mobile communications apparatus is arranged for transmitting the first connection request message, and determining whether the connection rejection message indicating network congestion has been received or whether a guard period of time corresponding to the first connection request message has expired. Also, the mobile communications apparatus is arranged for transmitting the second connection request message and waiting to receive the subsequent response message on the FACH, in response to the connection rejection message being received or the guard period of time being expired.

Other aspects and features of the invention will become apparent to those with ordinary skill in the art upon review of the following descriptions of specific embodiments of the mobile communications apparatuses, the service networks, and the connection setup methods.

### BRIEF DESCRIPTION OF DRAWINGS

The invention can be more fully understood by reading the subsequent detailed description and examples with references made to the accompanying drawings, wherein:

FIG. 1 is a message sequence chart illustrating an accepted Radio Resource Control (RRC) connection request;

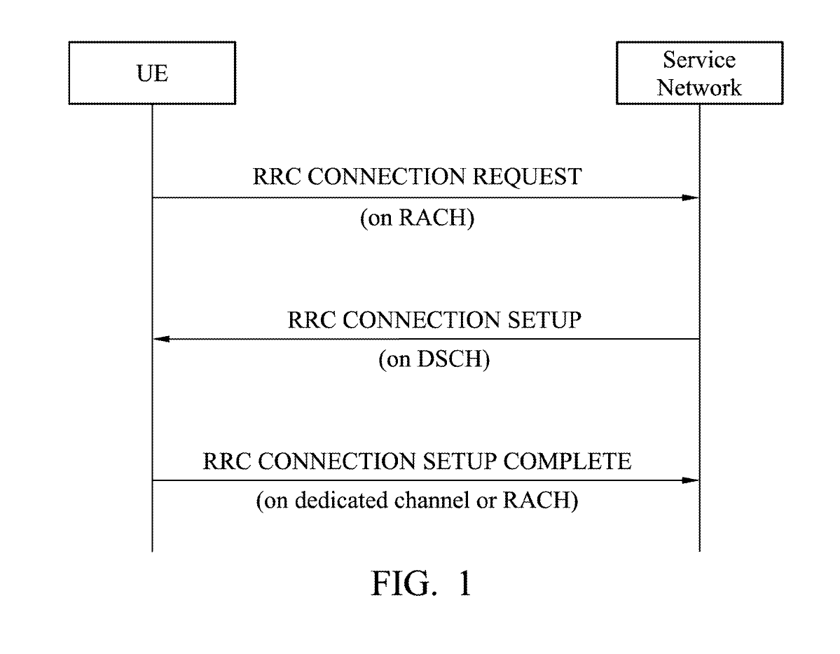

FIG. 2 is a message sequence chart illustrating a rejected RRC connection request;

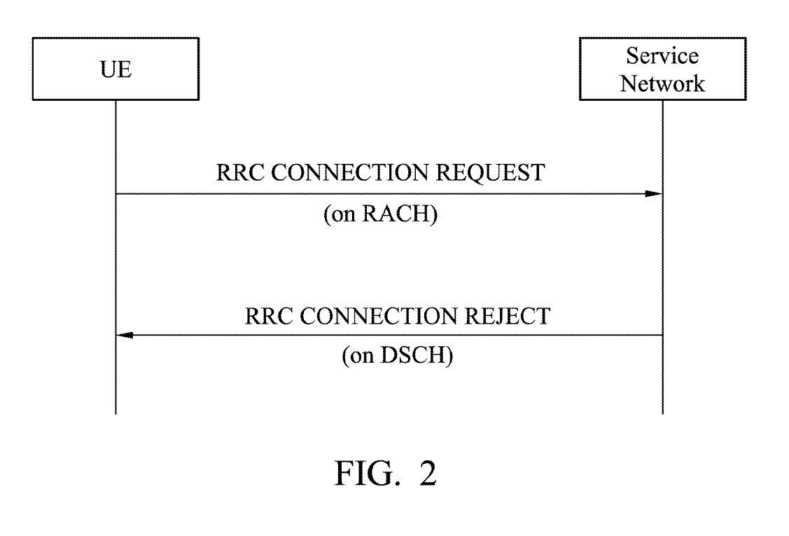

FIG. 3 is a block diagram illustrating a mobile communications system according to an embodiment of the invention;

FIG. 4 is a message sequence chart illustrating a connection setup procedure according to an embodiment of the invention;

FIG. 5 is a message sequence chart illustrating a connection setup procedure according to another embodiment of the invention;

FIG. 6 is a flow chart illustrating a connection setup method according to an embodiment of the invention;

FIG. 7 is a flow chart illustrating a connection setup method for handling a connection rejection message according to an embodiment of the invention; and

FIG. 8 is a flow chart illustrating a connection setup method for handling guard timer expiration according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The 3GPP specifications are used to teach the spirit of the invention, and the invention is not limited thereto.

The RRC CONNECTION REJECT message is transmitted on the Forward Access Channel (FACH) according to the Release 6 or any prior release of the UMTS specifications, and the Release 7 of the UMTS specifications is backward compatible with the Release 6 or any prior release of the UMTS specifications. Thus, the Release 7 of the UMTS specifications also supports using the FACH as a downlink channel. The invention takes into account that network congestion generally occurs only on the DSCH while the network resources on FACH are still available for wireless transceiving. In the situation where network congestion occurs on the DSCH but not the FACH, the retransmission of the RRC CONNECTION REQUEST message as described in the conventional design may occupy unnecessary network resources in the uplink direction. Thus, the invention proposes an improved connection setup method, in which a UE may downgrade to any prior release of the UMTS specifications to regenerate the RRC CONNECTION REQUEST message when receiving the RRC CONNECTION REJECT message, and transmit the regenerated RRC CONNECTION REQUEST message to the service network.

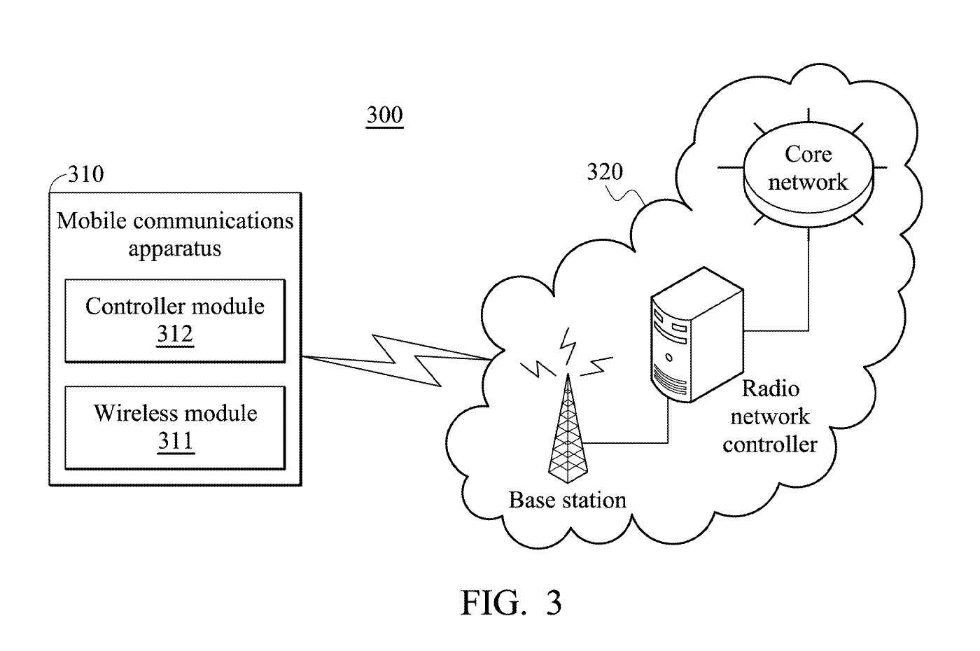

FIG. 3 is a block diagram illustrating a mobile communications system according to an embodiment of the invention. In the mobile communications system 300, the mobile communications apparatus 310 is wirelessly connected to the service network 320 for wireless transceiving therebetween, and both of the mobile communications apparatus 310 and the service network 320 support the Release 7 of the UMTS specifications. The mobile communication apparatus 310 may include a wireless module 311 for performing the functionality of wireless transceiving to and from the service network 320. To further clarify, the wireless module 311 may comprise a baseband unit (not shown) and a radio frequency (RF) unit (not shown). The baseband unit may contain multiple hardware devices to perform baseband signal processing, including analog to digital conversion (ADC)/digital to analog conversion (DAC), gain adjusting, modulation/demodulation, encoding/decoding, and so on. The RF unit may receive RF wireless signals, convert the received RF wireless signals to baseband signals, which are processed by the baseband unit, or receive baseband signals from the baseband unit and convert the received baseband signals to RF wireless signals, which are later transmitted. The RF unit may also contain multiple hardware devices to perform radio frequency conversion. For example, the RF unit may comprise a mixer to multiply the baseband signals with a carrier oscillated in the radio frequency of the wireless communications system, wherein the radio frequency may be 900 MHz, 1900 MHz, or 2100 MHz utilized in the UMTS, or others depending on the radio access technology (RAT) in use. Also, the mobile communication apparatus 310 may include a controller module 312 for controlling the operation of the wireless module 311 and other functional components, such as a display unit and/or keypad serving as the MMI (man-machine interface), a storage unit storing the program codes of applications or communication protocols, or others.

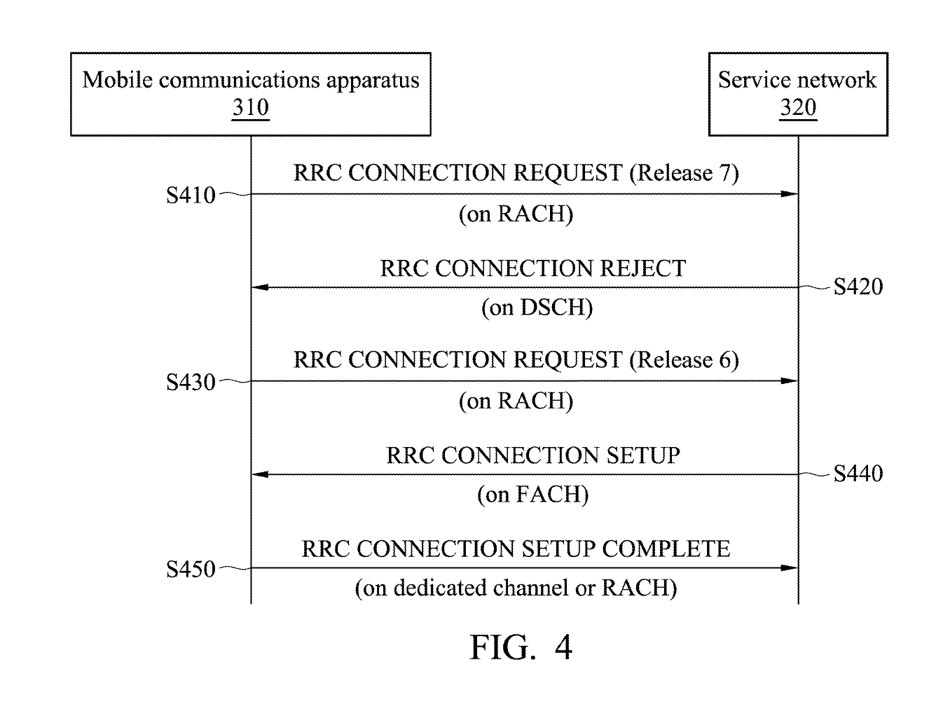

To be more specific, the controller module 312 controls the wireless module 311 for performing connection setup procedures with the service network 320. FIG. 4 is a message sequence chart illustrating a connection setup procedure according to an embodiment of the invention. Before starting the connection setup procedure, the mobile communication apparatus 310 is powered on to perform a series of initialization processes, including initialization of the wireless module 311, the control module 312, and other functional components. To begin, the control module 312 generates an RRC CONNECTION REQUEST message according to the Release 7 of the UMTS specifications (i.e., the RRC CONNECTION REQUEST message is generated with the data fields and parameters specified in the Release 7 of the UMTS specifications) and transmits the RRC CONNECTION REQUEST message to the service network 320 via the wireless module 311 (step S410). Next, the controller module 312 instructs the wireless module 311 to monitor the DSCH for receiving subsequent response messages from the service network 320. Although not shown, the controller module 312 may first receive the Primary System Information Blocks (Primary SIBs) broadcasted by the service network 320 via the wireless module 311, before the connection setup procedure is started. The Primary SIBs include a number 5 SIB (referred herein as SIB-5), and the monitoring of the DSCH as described above may be performed according to the configurations indicated in the SIB-5.

In this embodiment, the service network 320 does not accept the connection request due to network congestion (e.g., insufficient network resources on DSCH). The service network 320 further prepares an RRC CONNECTION REJECT message with a rejection cause indicating network congestion, and then transmits the RRC CONNECTION REJECT message to the mobile communication apparatus 310 (step S420). When receiving the RRC CONNECTION REJECT message via the wireless module 311, the controller module 312 finds that the rejection cause included in the RRC CONNECTION REJECT message indicates network congestion. In response to the rejection cause indicating network congestion, the control module 312 regenerates another RRC CONNECTION REQUEST message according to the Release 6 of the UMTS specifications and transmits the regenerated RRC CONNECTION REQUEST message to the service network 320 via the wireless module 311 (step S430). After that, the controller module 312 instructs the wireless module 311 to switch the monitored downlink channel to the FACH for receiving subsequent response messages from the service network 320. When receiving the regenerated RRC CONNECTION REQUEST message, the service network 320 finds that the data fields and parameters of the regenerated RRC CONNECTION REQUEST message are in compliance with the Release 6 of the UMTS specifications. The service network 320 then generates an RRC CONNECTION SETUP message having configurations for connection setup according to the Release 6 of the UMTS specifications, and transmits the RRC CONNECTION SETUP message, on the FACH, to the mobile communication apparatus 310 (step S440). Later, when receiving the RRC CONNECTION SETUP message on the FACH via the wireless module 311, the controller module 312 configures the wireless module 311 to establish a connection with the service network 320 according to the configurations included in the RRC CONNECTION SETUP message. Lastly, the controller module 312 generates an RRC CONNECTION SETUP COMPLETE message according to the Release 6 of the UMTS specifications, and transmits the RRC CONNECTION SETUP COMPLETE message to the service network (step S450) to end the connection setup procedure.

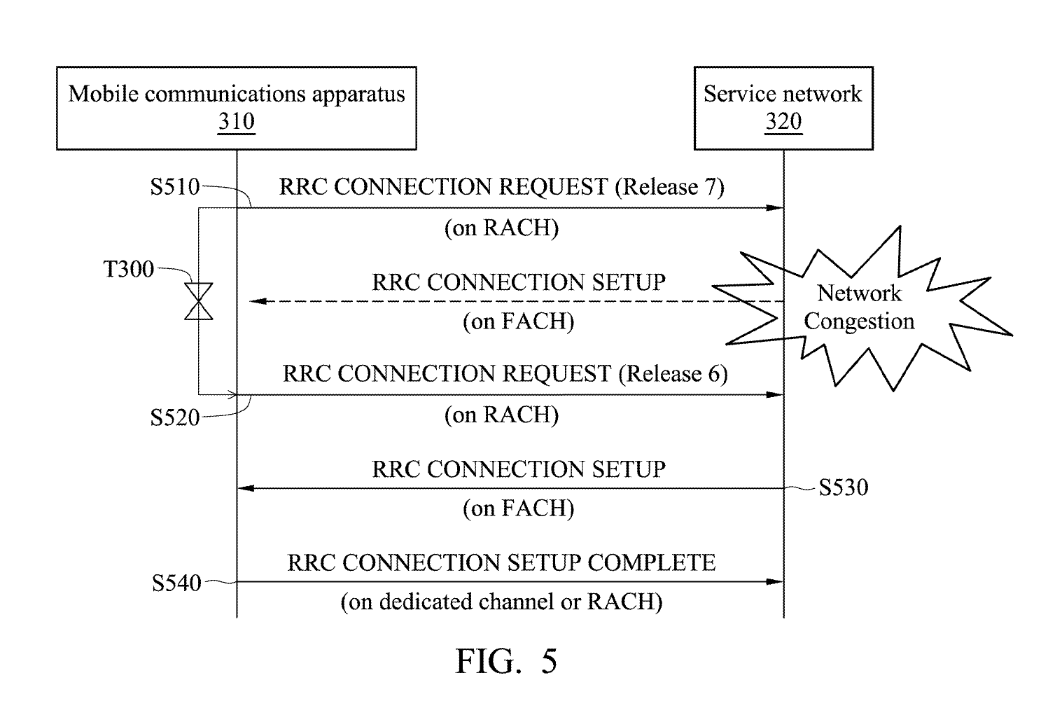

FIG. 5 is a message sequence chart illustrating a connection setup procedure according to another embodiment of the invention. In this embodiment, after transmitting an RRC CONNECTION REQUEST message to the service network 320 (step S510), the controller module 312 starts a guard timer which counts a predetermined period of time, T300, for controlling the retry of the RRC CONNECTION REQUEST message, in addition to instructing the wireless module 311 to monitor the DSCH. Although not shown, before the connection setup procedure is started, the controller module 312 may first receive the Primary SIBs broadcasted by the service network 320 via the wireless module 311. The Primary SIBs include a number 1 SIB (referred herein as SIB-1) which indicates the value setting of T300. When receiving the RRC CONNECTION REQUEST message, the service network 320 tries to reply to the mobile communication apparatus 310 with an RRC CONNECTION REJECT message due to network congestion, but the delivery of the RRC CONNECTION REJECT message has failed. Since no response message has been received from the service network 320, the guard timer keeps counting and expires when T300 is reached. In response to the expiration of the guard timer, the controller module 312 regenerates another RRC CONNECTION REQUEST message according to the Release 6 of the UMTS specifications and then transmits the regenerated RRC CONNECTION REQUEST message to the service network 320 via the wireless module 311 (step S520). Subsequently, the controller module 312 instructs the wireless module 311 to switch the monitored downlink channel to the FACH for receiving subsequent response messages from the service network 320. When receiving the regenerated RRC CONNECTION REQUEST message, the service network 320 finds that the data fields and parameters of the regenerated RRC CONNECTION REQUEST message are in compliance with the Release 6 of the UMTS specifications. The service network 320 then generates an RRC CONNECTION SETUP message having configurations for connection setup according to the Release 6 of the UMTS specifications, and transmits the RRC CONNECTION SETUP message, on the FACH, to the mobile communication apparatus 310 (step S530). After that, when receiving the RRC CONNECTION SETUP message on the FACH via the wireless module 311, the controller module 312 configures the wireless module 311 to establish a connection with the service network 320 according to the configurations included in the RRC CONNECTION SETUP message. Lastly, the controller module 312 generates an RRC CONNECTION SETUP COMPLETE message according to the Release 6 of the UMTS specifications, and transmits the RRC CONNECTION SETUP COMPLETE message to the service network (step S540) to end the connection setup procedure.

Note that, in the embodiments as shown in FIGS. 4 and 5, the controller module 312 may determine a specific channel for transmitting the RRC CONNECTION SETUP COMPLETE message according to the RRC operation status. For example, when the RRC operation status of the mobile communication apparatus 310 is CELL_DCH, the controller module 312 may determine to transmit the RRC CONNECTION SETUP COMPLETE message on a dedicated channel, or when the RRC operation status of the mobile communication apparatus 310 is CELL_FACH, the controller module 312 may determine to transmit the RRC CONNECTION SETUP COMPLETE message on the FACH. Although the latter RRC CONNECTION REQUEST message is regenerated according to the Release 6 of the UMTS specifications, the invention is not limited thereto. For example, the latter RRC CONNECTION REQUEST message may be regenerated according to the any prior release of the UMTS specifications, such as the Release 5, Release 4, or Release 99 of the UMTS specifications.

In addition to the downgrades of the UMTS specifications to regenerate the RRC CONNECTION REQUEST message, the controller module 312 may remove the “HS-PDSCH in CELL_FACH” Information Element (IE) from the original RRC CONNECTION REQUEST message, and then transmit the RRC CONNECTION REQUEST message including no “HS-PDSCH in CELL_FACH” IE to the service network 320 via the wireless module 311. Since the “HS-PDSCH in CELL_FACH” IE is used to indicate whether the new channel mapping relationships specified in the Release 7 of the UMTS specifications should be applied, the service network 320 may prepare an RRC CONNECTION SETUP message according to the Release 6 of the UMTS specifications when receiving the RRC CONNECTION REQUEST message without the “HS-PDSCH in CELL_FACH” IE, and then transmit the RRC CONNECTION SETUP message on the FACH to the mobile communication apparatus 310. When receiving the RRC CONNECTION SETUP message on the FACH, the mobile communication apparatus 310 may proceed to establish a connection with the service network 320 according to the configurations indicated in the RRC CONNECTION SETUP message.

In yet another embodiment, the controller module 312 may use a counter to count the number of times the transmission of the RRC CONNECTION REQUEST message is retried, and first determine whether the value of the counter is less than or equal to a predetermined threshold, N300, before the retransmission of the RRC CONNECTION REQUEST message. That is, the retransmission of the RRC CONNECTION REQUEST message may only be performed when the value of the counter is less than or equal to N300. Otherwise, when the value of the counter is greater than N300, the controller module 312 may instruct the wireless module 311 to stop monitoring the DSCH and enter the RRC_Idle state. Moreover, if the service network 320 decides to redirect the mobile communication apparatus 310 to another radio frequency or to a service network utilizing another Radio Access Technology (RAT) and rejects the connection request from the mobile communication apparatus 310, the service network 320 may include redirection information in an RRC CONNECTION REJCET message and transmit the RRC CONNECTION REJCET message to the mobile communication apparatus 310. When receiving the RRC CONNECTION REJCET message, the controller module 312 may configure the wireless module 311 to redirect to another radio frequency or to a service network utilizing another RAT according to the redirection information in the RRC CONNECTION REJCET message. Reference to the Release 7 of the UMTS specifications for a detailed description regarding the redirection operation may be made, and is omitted herein as it is beyond the scope of the invention.

In one embodiment, the RRC CONNECTION REJCET message may further comprise a “Wait time” IE for indicating to the mobile communication apparatus 310 that the RRC CONNECTION REQUEST message is to be retransmitted when a waiting period of time has passed after receiving the RRC CONNECTION REJCET message. Correspondingly, the controller module 312 may further determine the value of the “Wait time” IE, and wait for the waiting period of time before performing the retransmission of the RRC CONNECTION REQUEST message if the value of the “Wait time” IE is not 0. Alternatively, the controller module 312 may just ignore the “Wait time” IE and proceed to retransmit the RRC CONNECTION REQUEST message to speed up the connection setup procedure.

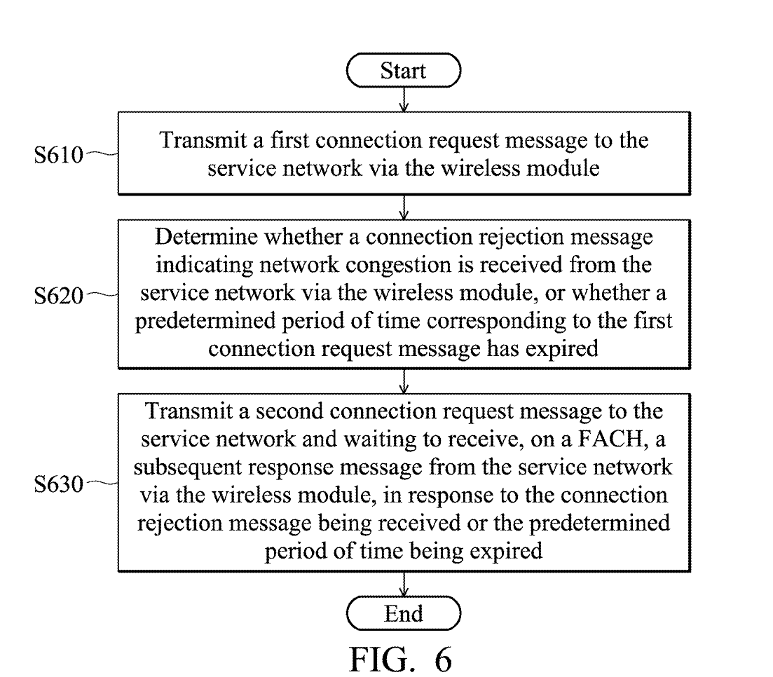

FIG. 6 is a flow chart illustrating a connection setup method according to an embodiment of the invention. In this embodiment, the connection setup method may be applied in a mobile communications apparatus including a wireless module for performing the function of wireless transceiving. To begin the connection setup method, the mobile communications apparatus transmits a first connection request message to a service network via the wireless module (step S610). Next, the mobile communications apparatus determines whether a connection rejection message indicating network congestion has been received from the service network via the wireless module, or whether a guard period of time corresponding to the first connection request message has expired (step S620). When the connection rejection message has been received or the guard period of time has expired, the mobile communications apparatus transmits a second connection request message to the service network and waits to receive, on the FACH, a subsequent response message from the service network via the wireless module (step S630). Specifically, if the received subsequent response message is a connection setup message, the mobile communications apparatus may establish a connection with the service network according to the connection setup message. Otherwise, if the received subsequent response message is another connection rejection message indicating network congestion, the mobile communications apparatus may repeat steps S610 to S630 to retransmit the connection rejection message until receiving the connection setup message or the number of retransmission of the connection rejection message exceeds a predetermined threshold.

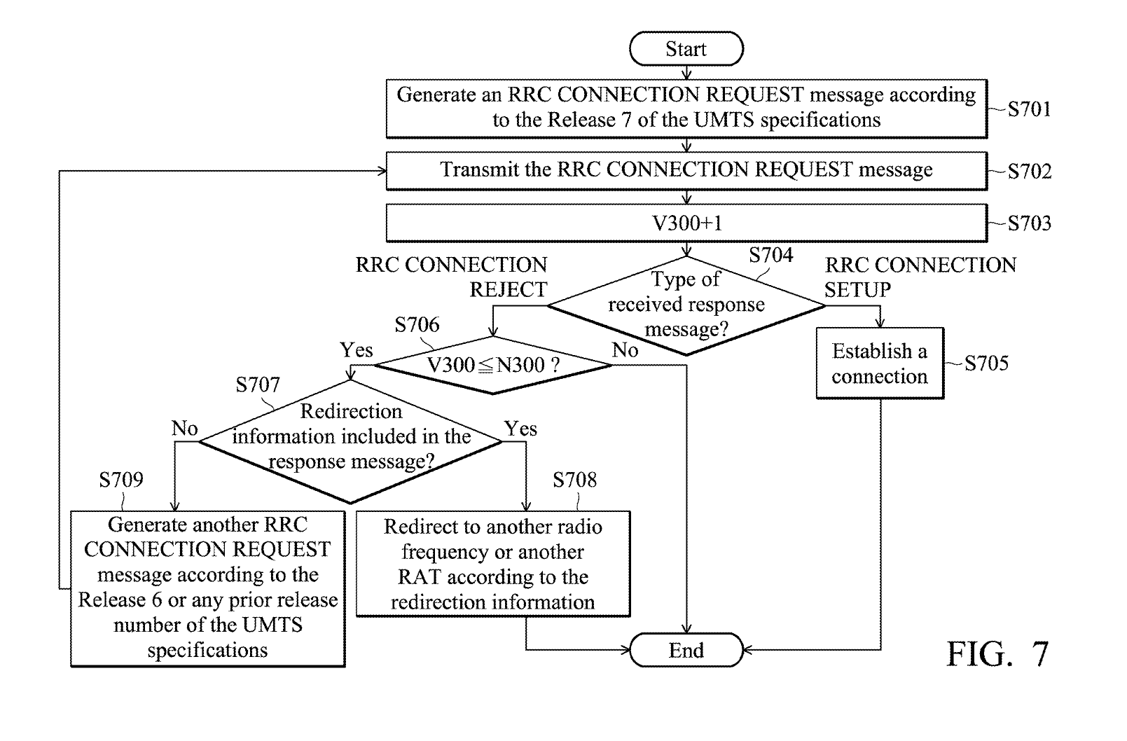

FIG. 7 is a flow chart illustrating a connection setup method for handling a connection rejection message according to an embodiment of the invention. In this embodiment, the connection setup method may be applied for a service network and a mobile communications apparatus wirelessly connected thereto, and both of the service network and the mobile communications apparatus support the Release 7 of the UMTS specifications. Taking the mobile communications apparatus 310 and the service network 320 as an example, the connection setup method is first started for the mobile communications apparatus 310 to generate an RRC CONNECTION REQUEST message according to the Release 7 of the UMTS specifications (step S701). The mobile communications apparatus 310 then transmits the RRC CONNECTION REQUEST message to the service network 320 (step S702), and starts a retry counter, V300, for counting the number of transmitted RRC CONNECTION REQUEST messages (step S703). Subsequently, the mobile communications apparatus 310 receives, on the DSCH, a response message from the service network 320 (step S704). If the response message is an RRC CONNECTION SETUP message, the mobile communications apparatus 310 establishes a connection with the service network 320 according to the configurations indicated in the RRC CONNECTION SETUP message (step S705). Otherwise, if the response message is an RRC CONNECTION REJECT message, the mobile communications apparatus 310 determines whether the value of V300 is less than or equal to a predetermined threshold, N300 (step S706). If so, the mobile communications apparatus 310 further determines whether the RRC CONNECTION REJECT message comprises redirection information (step S707). If the RRC CONNECTION REJECT message comprises redirection information, the mobile communications apparatus 310 redirects to another radio frequency of the service network 320 or to another service network utilizing a RAT other than the WCDMA technology (step S708). If the RRC CONNECTION REJECT message does not comprise redirection information, the mobile communications apparatus 310 regenerates another RRC CONNECTION REQUEST message according to the Release 6 or any prior release of the UMTS specifications (step S709), and then repeats steps S702 to S709. Subsequent to step S706, if the value of V300 is greater than N300, the mobile communications apparatus 310 enters the RRC_Idle state to end the connection setup method.

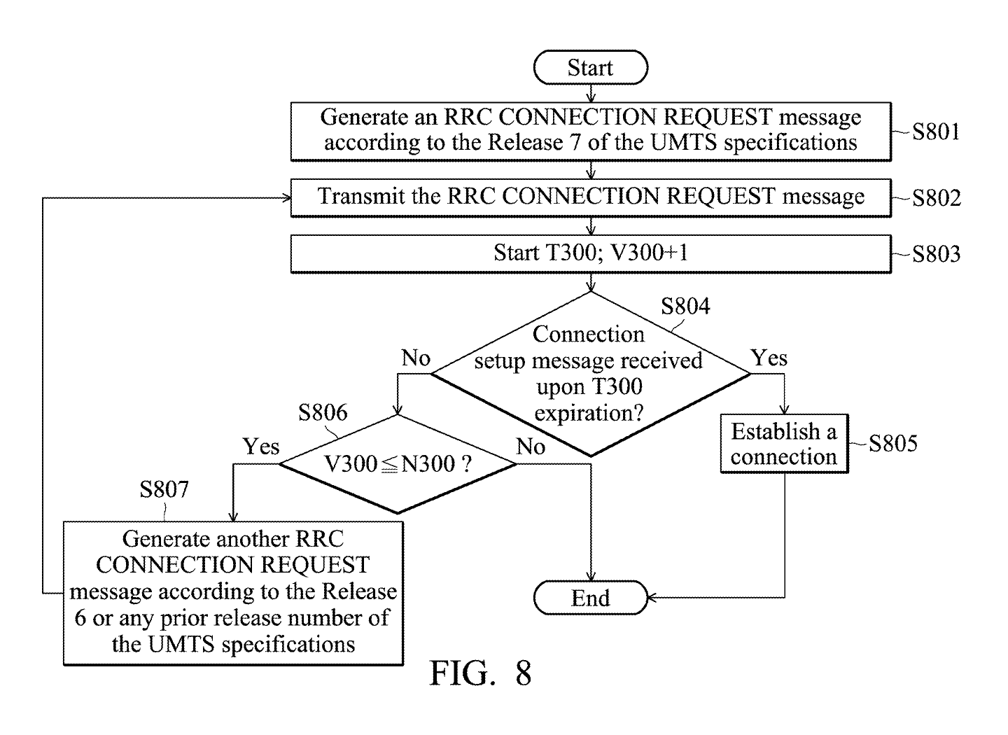

FIG. 8 is a flow chart illustrating a connection setup method for handling guard timer expiration according to an embodiment of the invention. Similar to the embodiment in FIG. 7, both of the service network and the mobile communications apparatus suitable for the connection setup method support the Release 7 of the UMTS specifications, and the following description is made with respect to the service network 320 and the mobile communications apparatus 310. To begin the connection setup method, the mobile communications apparatus 310 generates an RRC CONNECTION REQUEST message according to the Release 7 of the UMTS specifications (step S801), and transmits the RRC CONNECTION REQUEST message to the service network 320 (step S802). Upon transmitting the RRC CONNECTION REQUEST message, the mobile communications apparatus 310 starts a guard timer for counting a predetermine period of time, T300, and starts a counter, V300, for counting the number of the transmitted RRC CONNECTION REQUEST message (step S803). Subsequently, the mobile communications apparatus 310 determines whether an RRC CONNECTION SETUP message has been received from the service network 320 when the guard timer expires (step S804). If so, the mobile communications apparatus 310 establishes a connection with the service network 320 according to the configurations indicated in the RRC CONNECTION SETUP message (step S805). Otherwise, if no RRC CONNECTION SETUP message is received when the guard timer expires, the mobile communications apparatus 310 then determines whether the value of V300 is less than or equal to a predetermine limit, N300 (step S806). If so, the mobile communications apparatus 310 regenerates another RRC CONNECTION REQUEST message according to the Release 6 or any prior release of the UMTS specifications (step S807), and repeats steps S802 to S807. Subsequent to step S806, if the value of V300 is greater than N300, the mobile communications apparatus 310 enters the RRC_Idle state to end the connection setup method.

Note that the retransmitted RRC CONNECTION REQUEST message described in the embodiments in FIGS. 7 and 8 is generated according to the Release 6 or any prior release of the UMTS specifications. That is, the retransmitted RRC CONNECTION REQUEST message may be generated according to the Release 6, Release 5, Release 4, or Release 99 of the UMTS specifications, and the invention is not limited thereto. In addition to downgrading to prior release of the UMTS specifications for generating the RRC CONNECTION REQUEST message to be retransmitted, the connection setup method may remove the “HS-PDSCH in CELL_FACH” IE from the original RRC CONNECTION REQUEST message and transmit the RRC CONNECTION REQUEST message without the “HS-PDSCH in CELL_FACH” IE to the service network 320, in response to receiving the RRC CONNECTION REJECT message or to the expiration of T300. Since the “HS-PDSCH in CELL_FACH” IE is used to indicate whether the new channel mapping relationships specified in the Release 7 of the UMTS specifications should be applied, the service network 320 may prepare an RRC CONNECTION SETUP message according to the Release 6 of the UMTS specifications when receiving the RRC CONNECTION REQUEST message without the “HS-PDSCH in CELL_FACH” IE, and then transmit the RRC CONNECTION SETUP message on the FACH to the mobile communication apparatus 310. Thus, the mobile communication apparatus 310 may proceed to establish a connection with the service network 320 according to the configurations indicated in the RRC CONNECTION SETUP message, and the time required for connection setup in the situation where network congestion occurs on the DSCH may be reduced efficiently.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the invention shall be defined and protected by the following claims and their equivalents.

What is claimed is:

1. A mobile communications apparatus, comprising:
a wireless module, arranged for performing wireless transceiving operations to and from a service network; and
a controller module, arranged for transmitting a first connection request message to the service network via the wireless module, determining whether a connection rejection message indicating network congestions has been received from the service network via the wireless module, or whether a predetermined period of time corresponding to the first connection request message has expired, and transmitting a second connection request message to the service network and waiting to receive, on a Forward Access CHannel (FACH), a subsequent response message from the service network via the wireless module, in response to the connection rejection message being received or the predetermined period of time being expired,
wherein the first connection request message and the second connection request message are generated according to a first version and a second version of a communication protocol, respectively.

2. The mobile communications apparatus of claim 1, wherein, in response to the subsequent response message being a connection setup message, the controller module is further arranged for instructing the wireless module to establish a connection with the service network according to the connection setup message.

3. The mobile communications apparatus of claim 1, wherein the communication protocol is standardized by the 3rd Generation Partnership Project (3GPP) for a Universal Mobile Telecommunications System (UMTS), the first version is the Release 7, and the second version is the Release 6 or any prior release number.

4. The mobile communications apparatus of claim 1, wherein the first connection request message comprises information concerning a High Speed Downlink Shared CHannel (HS-PDSCH), and the second connection request message does not comprise information concerning the HS-PDSCH.

5. The mobile communications apparatus of claim 1, wherein the controller module is further arranged for determining whether a counted number for the transmission of the first and second connection request messages is less than or equal to a predetermined threshold, prior to transmitting the second connection request message, and for performing the steps of the transmission of the second connection request message and the wait for the reception on the FACH in response to the counted number being less than or equal to the predetermined threshold, and entering an idle mode in response to the counted number not being less than or equal to the predetermined threshold.

6. The mobile communications apparatus of claim 1, wherein the controller module is further arranged for receiving a system information broadcast from the service network via the wireless module, and upon transmitting the first connection request message, for starting a guard timer for counting the predetermined period of time according to the system information broadcast.

7. A connection setup method for a mobile communications apparatus with a wireless module, comprising:
transmitting a first connection request message to the service network via the wireless module;
determining whether a connection rejection message indicating network congestion has been received from the service network via the wireless module, or whether a predetermined period of time corresponding to the first connection request message has expired; and
transmitting a second connection request message to the service network and waiting to receive, on a Forward Access CHannel (FACH), a subsequent response message from the service network via the wireless module, in response to the connection rejection message being received or the predetermined period of time being expired,
wherein the first connection request message and the second connection request message are generated according to a first version and a second version of a communication protocol, respectively.

8. The connection setup method of claim 7, further comprising, in response to the subsequent response message being a connection setup message, instructing the wireless module to establish a connection with the service network according to the connection setup message.

9. The connection setup method of claim 7, wherein the communication protocol is standardized by the 3rd Generation Partnership Project (3GPP) for a Universal Mobile Telecommunications System (UMTS), the first version is the Release 7, and the second version is the Release 6 or any prior release number.

10. The connection setup method of claim 7, wherein the first connection request message comprises information concerning a High Speed Downlink Shared CHannel (HS-PDSCH), and the second connection request message does not comprise information concerning the HS-PDSCH.

11. The connection setup method of claim 7, further comprising determining whether a counted number for the transmission of the first and second connection request messages is less than or equal to a predetermined threshold, prior to the transmission of the second connection request message, performing the steps of the transmission of the second connection request message and the wait for the reception on the FACH in response to the counted number being less than or equal to the predetermined threshold, and entering an idle mode in response to the counted number not being less than or equal to the predetermined threshold.

12. The connection setup method of claim 7, further comprising receiving a system information broadcast from the service network via the wireless module, and upon transmitting the first connection request message, starting a guard timer for counting the predetermined period of time according to the system information broadcast.

13. A mobile communications system, comprising:
a service network, arranged for receiving a first connection request message, transmitting a connection rejection message when network congestion occurs, and transmitting a subsequent response message on a Forward Access CHannel (FACH) in response to receiving a second connection request message, wherein the first connection request message and the second connection request message are generated according to a first version and a second version of a communication protocol, respectively; and
a mobile communications apparatus, arranged for transmitting the first connection request message, determining whether the connection rejection message indicating network congestion has been received or whether a predetermined period of time corresponding to the first connection request message has expired, and transmitting the second connection request message and waiting to receive the subsequent response message on the FACH, in response to the connection rejection message being received or the predetermined period of time being expired.

14. The mobile communications system of claim 13, wherein, in response to the subsequent response message being a connection setup message, the mobile communications apparatus is further arranged for establishing a connection with the service network according to the connection setup message.

15. The mobile communications system of claim 13, wherein the communication protocol is standardized by the 3rd Generation Partnership Project (3GPP) for a Universal Mobile Telecommunications System (UMTS), the first version is the Release 7, and the second version is the Release 6 or any prior release number.

16. The mobile communications system of claim 13, wherein the first connection request message comprises information concerning a High Speed Downlink Shared CHannel (HS-PDSCH), and the second connection request message does not comprise information concerning the HS-PDSCH.

17. The mobile communications system of claim 13, wherein the mobile communications apparatus is further arranged for determining whether a counted number for the transmission of the first and second connection request messages is less than or equal to a predetermined threshold, prior to transmitting the second connection request message, and for performing the steps of the transmission of the second connection request message and the wait for the reception on the FACH in response to the counted number being less than or equal to the predetermined threshold, and entering an idle mode in response to the counted number not being less than or equal to the predetermined threshold.

18. The mobile communications system of claim 13, wherein the mobile communications apparatus is further arranged for receiving a system information broadcast from the service network via the wireless module, and upon transmitting the first connection request message, for starting a guard timer for counting the predetermined period of time according to the system information broadcast.
